(19) United States
(12) Patent Application Publication
(10) Pub. No.: US 2023/0056485 A1
(43) Pub. Date: Feb. 23, 2023

(54) SERVER APPARATUS, INFORMATION PROVISION SYSTEM, AND METHOD OF OPERATING INFORMATION PROVISION SYSTEM

(71) Applicant: TOYOTA JIDOSHA KABUSHIKI KAISHA, Toyota-shi (JP)

(72) Inventors: Toyokazu NAKASHIMA, Nagoya-shi (JP); Takeshi TAKEMOTO, Nagoya-shi (JP); Naoko YAMAFUJI, Nagoya-shi (JP); Naoya OKA, Nagakute-shi (JP)

(73) Assignee: TOYOTA JIDOSHA KABUSHIKI KAISHA, Toyota-shi (JP)

(21) Appl. No.: 17/820,743

(22) Filed: Aug. 18, 2022

(30) Foreign Application Priority Data
Aug. 18, 2021 (JP) 2021-133662

(51) Int. Cl. G06Q 30/02

(52) U.S. Cl. CPC G06Q 30/0278; G06Q 30/0201

(57) ABSTRACT

A server apparatus includes a communication interface and a controller configured to communicate using the communication interface. The controller receives, from a terminal apparatus, information indicating an item of history information that affects appraisal of a first vehicle among history information regarding a condition of the first vehicle and transmits, to a second vehicle, information for presentation to a user when the item of history information regarding a condition of the second vehicle exhibits a predetermined form.

### CROSS-REFERENCE TO RELATED APPLICATION

This application claims priority to Japanese Patent Application No. 2021-133662, filed on Aug. 18, 2021, the entire contents of which are incorporated herein by reference.

### TECHNICAL FIELD

The present disclosure relates to a server apparatus, an information provision system, and a method of operating an information provision system.

### BACKGROUND

In the used car market for trading used cars, the sale price of a vehicle is appraised based on the condition of the vehicle being traded. As technology for improving the accuracy of vehicle appraisals, Patent Literature (PTL) 1, for example, discloses a system that performs appraisals using data such as driving conditions collected from a vehicle.

### CITATION LIST

### Patent Literature

PTL 1: JP 2012-174102 A

### SUMMARY

The detection results from various sensors installed in a vehicle provide a variety of history information regarding the condition of the vehicle, but methods for using such history information have room for improvement.

It would be helpful to provide a server apparatus and the like that enable the effective use of history information obtained from vehicles.

A server apparatus according to the present disclosure includes:

a communication interface; and

a controller configured to communicate using the communication interface, wherein

the controller
receives, from a terminal apparatus, information indicating an item of history information that affects appraisal of a first vehicle among history information regarding a condition of the first vehicle, and
transmits, to a second vehicle, information for presentation to a user when the item of history information regarding a condition of the second vehicle exhibits at least one predetermined form.

An information provision system according to the present disclosure includes a vehicle and a server apparatus configured to communicate with the vehicle, wherein

the server apparatus receives, from a terminal apparatus, information indicating an item of history information that affects appraisal of a first vehicle among history information regarding a condition of the first vehicle and transmits, to a second vehicle, information for presentation to a user when the item of history information regarding a condition of the second vehicle exhibits at least one predetermined form, and

the second vehicle outputs the information for presentation to the user.

A method of operating an information provision system according to the present disclosure is a method of operating an information provision system that includes a vehicle and a server apparatus configured to communicate with the vehicle, the method including:

receiving from a terminal apparatus, by the server apparatus, information indicating an item of history information that affects appraisal of a first vehicle among history information regarding a condition of the first vehicle;

transmitting to a second vehicle, by the server apparatus, information for presentation to a user when the item of history information regarding a condition of the second vehicle exhibits a predetermined form; and

outputting, by the second vehicle, the information for presentation to the user.

According to the server apparatus and the like in the present disclosure, the history information obtained from a vehicle can be used effectively.

### BRIEF DESCRIPTION OF THE DRAWINGS

In the accompanying drawings:

FIG. 1 is a diagram illustrating an example configuration of an information provision system;

FIG. 2 is a diagram illustrating an example configuration of a server apparatus;

FIG. 3 is a diagram illustrating an example configuration of a vehicle;

FIG. 4 is a diagram illustrating an example configuration of a terminal apparatus;

FIG. 5 is a sequence diagram illustrating an example of operations of an information provision system;

FIG. 6 is a sequence diagram illustrating an example of operations of an information provision system; and

FIG. 7 is a sequence diagram illustrating an example of operations of an information provision system.

### DETAILED DESCRIPTION

Embodiments are described below.

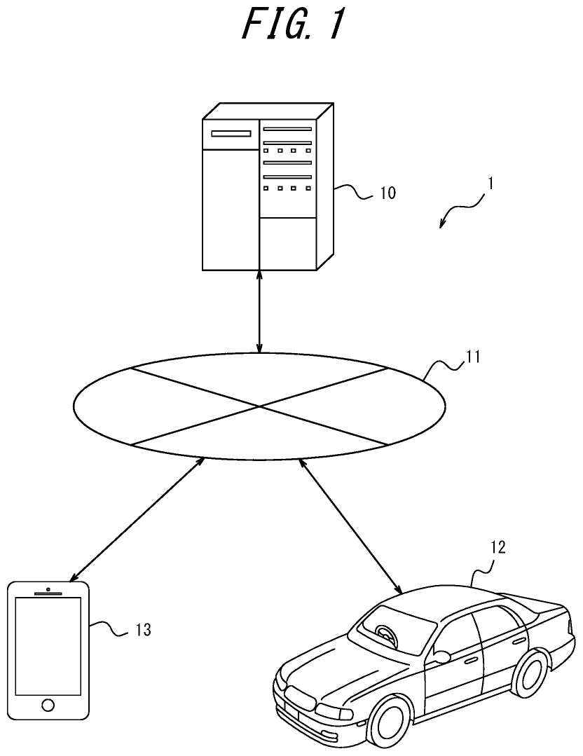

FIG. 1 is a diagram illustrating an example configuration of an information provision system in an embodiment. An information provision system 1 includes one or more each of a server apparatus 10, a vehicle 12, and a terminal apparatus 13 communicably connected to each other via a network 11. The server apparatus 10 is, for example, a server computer that belongs to a cloud computing system or other computing system and functions as a server that implements various functions. The vehicle 12 is a passenger car, a commercial vehicle, or the like provided with communication functions and information processing functions and connects to the network 11 via a mobile communication network. The vehicle 12 is driven manually, but a portion of driving may be automated. The vehicle 12 is any type of automobile such as a gasoline vehicle, a Battery Electric Vehicle (BEV), a Hybrid Electric Vehicle (HEV), a Plug-in Hybrid Electric Vehicle (PHEV), or a Fuel Cell Electric Vehicle (FCEV). The terminal apparatus 13 is an information processing apparatus used by the user of the vehicle 12 or by a sales representative at the dealer of the vehicle 12. The user of the vehicle 12 is the person who owns the vehicle 12 and operates or maintains/manages the vehicle 12. Examples of the terminal apparatus 13 include a smartphone, a tablet terminal, and a personal computer (PC). The network 11 is the Internet, for example, but may also be an ad-hoc network, a LAN, a Metropolitan Area Network (MAN), other networks, or a combination of two or more thereof.

When a vehicle 12 owned by a user is to be sold, the vehicle 12 is appraised by a sales representative of the dealer (hereinafter referred to as the “appraiser”), and the appraisal value is determined. The server apparatus 10 in the present embodiment uses history information about the condition of the vehicle 12, obtained from the detection results of various sensors mounted in the vehicle 12, and provides information to the user of the vehicle 12 so that the vehicle 12 can receive a better appraisal when the vehicle 12 is traded as a used vehicle. Specifically, the server apparatus 10 includes a communication interface and a controller that communicates via the communication interface. The controller receives, from the terminal apparatus 13, information indicating items (reference items) of history information that affected the appraisal of the vehicle 12 among history information regarding the condition of the vehicle 12 that was appraised when traded. When the traded vehicle 12 or another vehicle 12 is to be used, the controller then transmits, to the vehicle 12, information for presentation to the user when the history information for a reference item regarding the condition of the vehicle 12 exhibits a predetermined form. The predetermined form exhibited by the history information for a reference item is a form suggesting a condition that would adversely affect the appraisal of the vehicle 12. Therefore, the information for presentation to the user is information to warn the user about adverse effects on the appraisal. Reference items that affect the appraisal are identified based on the appraiser's experience, but according to the present embodiment, a warning is provided to the user according to history information for reference items on the vehicle 12 in use. A reduction in the appraisal value can thus be suppressed. In other words, a decrease in the market value of the vehicle 12 can be suppressed, and a higher sales price for the vehicle 12 can be secured. In this way, the history information obtained from the vehicle 12 can be used effectively.

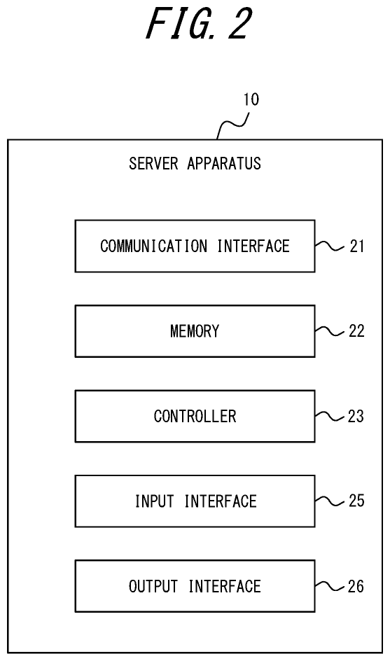

FIG. 2 illustrates an example configuration of the server apparatus 10. The server apparatus 10 includes a communication interface 21, a memory 22, a controller 23, an input interface 25, and an output interface 26. The server apparatus 10 is, for example, a single computer. The server apparatus 10 may be two or more computers that are communicably connected to each other and operate in cooperation. In this case, the configuration illustrated in FIG. 2 can be arranged among two or more computers as appropriate.

The communication interface 21 includes one or more interfaces for communication. The interface for communication is, for example, a LAN interface. The communication interface 21 receives information to be used for the operations of the server apparatus 10 and transmits information obtained by the operations of the server apparatus 10. The server apparatus 10 is connected to the network 11 by the communication interface 21 and communicates information with the vehicle 12 or the terminal apparatus 13 via the network 11.

The memory 22 includes, for example, one or more semiconductor memories, one or more magnetic memories, one or more optical memories, or a combination of at least two of these types, to function as main memory, auxiliary memory, or cache memory. The semiconductor memory is, for example, random access memory (RAM) or read only memory (ROM). The RAM is, for example, static RAM (SRAM) or dynamic RAM (DRAM). The ROM is, for example, electrically erasable programmable ROM (EEPROM). The memory 22 stores information to be used for the operations of the server apparatus 10 and information obtained by the operations of the server apparatus 10.

The controller 23 includes one or more processors, one or more dedicated circuits, or a combination thereof. The processor is a general purpose processor, such as a central processing unit (CPU), or a dedicated processor, such as a graphics processing unit (GPU), specialized for a particular process. The dedicated circuit is, for example, a field-programmable gate array (FPGA), an application specific integrated circuit (ASIC), or the like. The controller 23 executes information processing related to operations of the server apparatus 10 while controlling components of the server apparatus 10.

The input interface 25 includes one or more interfaces for input. The interface for input is, for example, a physical key, a capacitive key, a pointing device, a touch screen integrally provided with a display, or a microphone that receives audio input. The input interface 25 accepts operations to input information used for operation of the server apparatus 10 and transmits the inputted information to the controller 23.

The output interface 26 includes one or more interfaces for output. The interface for output is, for example, a display or a speaker. The display is, for example, a liquid crystal display (LCD) or an organic electro-luminescent (EL) display. The output interface 26 outputs information obtained by the operations of the server apparatus 10.

The functions of the server apparatus 10 are realized by a processor included in the controller 23 executing a control program. The control program is a program for causing a computer to execute the processing of steps included in the operations of the server apparatus 10, thereby enabling the computer to realize the functions corresponding to the processing of the steps. That is, the control program is a program for causing a computer to function as the server apparatus 10. Some or all of the functions of the server apparatus 10 may be realized by a dedicated circuit included in the controller 23. The control program may be stored on a non-transitory recording/storage medium readable by the server apparatus 10 and be read from the medium by the server apparatus 10.

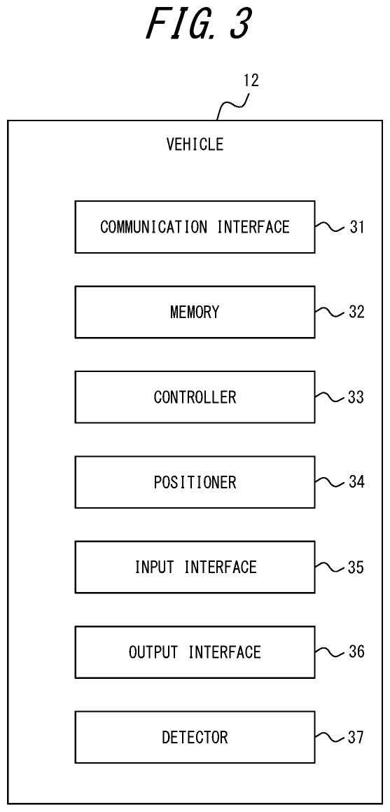

FIG. 3 illustrates an example configuration of the vehicle 12 related to the present embodiment. The vehicle 12 includes a communication interface 31, a memory 32, a controller 33, a positioner 34, an input interface 35, an output interface 36, and a detector 37. These components may be configured as a single control apparatus, by two or more control apparatuses, or by other apparatuses, such as a control apparatus and a communication device. The control apparatus includes an electronic control unit (ECU), for example. The communication device includes a data communication module (DCM), for example. The control apparatus may be configured to include a personal computer, a tablet terminal, a smartphone terminal, a navigation apparatus, or the like. The components are communicably connected to each other, or to other devices and apparatuses in the vehicle 12, by an in-vehicle network compliant with standards such as a controller area network (CAN).

The communication interface 31 includes one or more interfaces for communication. Examples of the interface for communication include an interface corresponding to mobile communication standards, such as Long Term Evolution (LTE), 4th Generation (4G), or 5th Generation (5G). The communication interface 31 receives information to be used for the operations of the controller 33 and transmits information obtained by the operations of the controller 33. The controller 33 connects to the network 11 using the communication interface 31 through a mobile communication base station and communicates information with other apparatuses via the network 11.

The memory 32 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores information to be used for the operations of the controller 33 and information obtained by the operations of the controller 33.

The controller 33 includes one or more processors, one or more dedicated circuits, or a combination thereof. Examples of the processor include a general purpose processor such as a CPU and a dedicated processor dedicated to specific processing. The dedicated circuit is, for example, an FPGA or an ASIC. The controller 33 executes information processing related to operations of the vehicle 12 while controlling the components of the controller 33.

The positioner 34 includes one or more Global Navigation Satellite System (GNSS) receivers. The GNSS includes, for example, at least one of Global Positioning System (GPS), Quasi-Zenith Satellite System (QZSS), BeiDou, Global Navigation Satellite System (GLONASS), and Galileo. The positioner 34 acquires the positional information for the vehicle 12 and transmits the positional information to the controller 33.

The input interface 35 includes one or more interfaces for input. The interface for input is, for example, a physical key, a capacitive key, a pointing device, a touch screen integrally provided with a display, or a microphone that receives audio input. The interface for input may further include a camera or IC card reader that captures images or image codes. The input interface 35 accepts user operations to input information used for operation of the controller 33 and transmits the inputted information to the controller 33.

The output interface 36 includes one or more interfaces for output. The interface for output is, for example, a display or a speaker. The display is, for example, an LCD or an organic EL display. The output interface 36 outputs the information obtained by the operation of controller 33, for example, to the user.

The detector 37 includes one or more sensors, or interfaces with sensors, that detect the condition or operation of various components in the vehicle 12 and transmits information indicating the results of detection by the sensors to the controller 33. The sensors include sensors that detect the condition or operation of the drive mechanisms of the vehicle 12, such as the engine, motor, battery, fuel cell, and power train. The sensors also include sensors that detect the condition or operation of the control mechanisms for the movement of the vehicle 12, such as the suspension and brakes. The sensors also include sensors that detect the condition or operation of the occupant environment of the vehicle 12, such as airbags, lighting, air conditioning, doors, and door locks. The sensors also include sensors that detect the condition or operation of the driving control mechanisms that accept operations to operate the drive mechanism or motion control mechanism. The sensors also include sensors that detect events acting on the body of the vehicle 12, such as acceleration and flooding. The sensors also include radar, image sensors, infrared sensors, and other such sensors that detect the presence of other objects around the vehicle 12, the distance to those objects, and the like. The detector 37 may acquire control information from the various ECUs mounted in the vehicle 12 as information indicating the condition or operation of the vehicle 12. Such information includes, for example, information indicating whether warning information is outputted to warn of proximity to another object and whether intervention in driving operations is required to avoid contact with another object.

The functions of the controller 33 are realized by a processor included in the controller 33 executing a control program. The control program is a program for causing a computer to execute the processing of steps included in operations of the controller 33, thereby enabling the computer to realize the functions corresponding to the processing of the steps. That is, the control program is a program for causing a computer to function as the controller 33. Some or all of the functions of the controller 33 may be realized by a dedicated circuit included in the controller 33.

The controller 33 generates information for control of various mechanisms and apparatuses of the vehicle 12 and transmits the information for control to the control circuits of the various mechanisms and apparatuses to control the mechanisms and apparatuses. The controller 33 may intervene in driving operations by controlling mechanisms that accept driving operations.

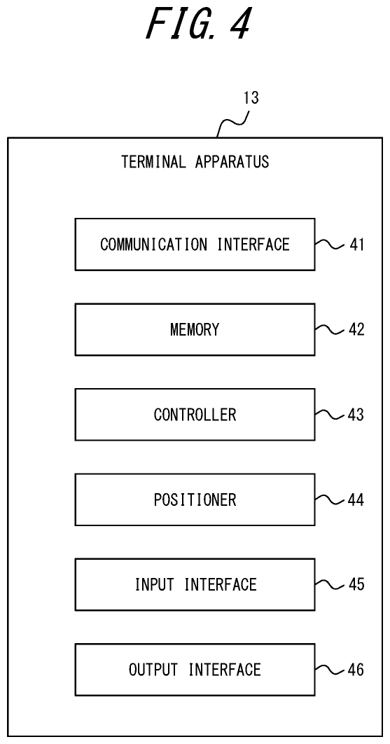

FIG. 4 is a diagram illustrating a configuration of the terminal apparatus 13. The terminal apparatus 13 is, for example, an information terminal apparatus such as a smartphone, a tablet terminal apparatus, or a personal computer. The terminal apparatus 13 includes a communication interface 41, a memory 42, a controller 43, an input interface 45, and an output interface 46. The terminal apparatus 13 may include a positioner 44.

The communication interface 41 includes a communication module compliant with a wired or wireless LAN standard, a module compliant with a mobile communication standard such as LTE, 4G, or 5G, or the like. The terminal apparatus 13 connects to the network 11 via a nearby router apparatus or mobile communication base station using the communication interface 41 and communicates information with other apparatuses over the network 11.

The memory 42 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 42 functions as, for example, a main memory, an auxiliary memory, or a cache memory. The memory 42 stores information to be used for the operations of the controller 43 and information obtained by the operations of the controller 43.

The controller 43 has one or more general purpose processors such as CPUs or micro processing units (MPUs) or one or more dedicated processors that are dedicated to specific processing. Alternatively, the controller 43 may have one or more dedicated circuits such as FPGAs or ASICs. The controller 43 is configured to perform overall control of the operations of the terminal apparatus 13 by operating according to the control/processing programs or operating according to operation procedures implemented in the form of circuits. The controller 43 then transmits and receives various types of information to and from the server apparatus 10 and the like via the communication interface 41 and executes the operations according to the present embodiment.

The positioner 44 includes one or more GNSS receivers. GNSS includes, for example, GPS, QZSS, BeiDou, GLONASS, and/or Galileo. The positioner 44 acquires the positional information for the terminal apparatus 13 and transmits the positional information to the controller 43.

The input interface 45 includes one or more interfaces for input. The interface for input is, for example, a physical key, a capacitive key, a pointing device, a touch screen integrally provided with a display, or a microphone that receives audio input. The interface for input may further include a camera or IC card reader that captures images or image codes. The input interface 45 accepts operations for inputting information to be used in the operations of the controller 43 and transmits the inputted information to the controller 43.

The output interface 46 includes one or more interfaces for output. The interface for output is, for example, a display or a speaker. The display is, for example, an LCD or an organic EL display. The output interface 46 outputs information obtained by the operations of the controller 43.

The functions of the controller 43 are realized by a processor included in the controller 43 executing a control program. The control program is a program for causing the processor to function as the controller 43. Some or all of the functions of the controller 43 may be realized by a dedicated circuit included in the controller 43.

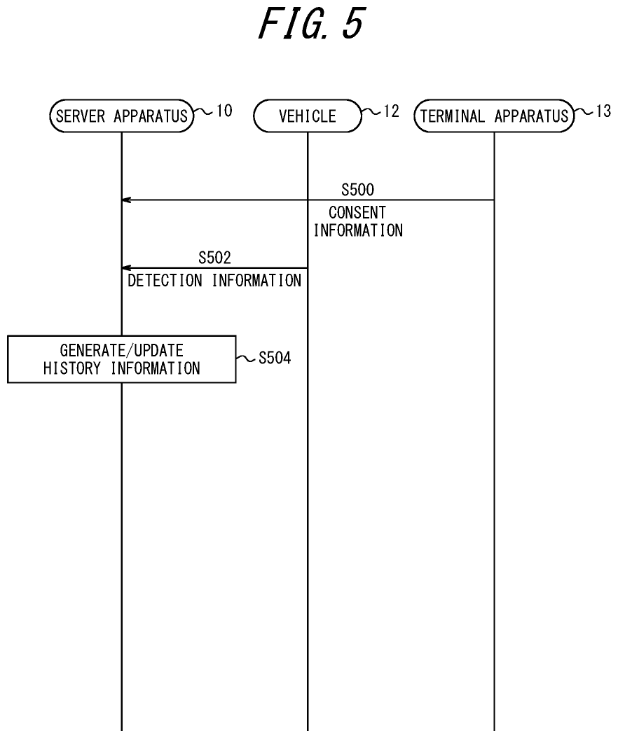

FIGS. 5 through 7 are sequence diagrams to illustrate the operating procedures of the information provision system 1 in the present embodiment. FIGS. 5 through 7 illustrate the steps in the coordinated operation of the server apparatus 10, the vehicle 12, and the terminal apparatus 13. The server apparatus 10 can perform the procedures illustrated in FIGS. 5 through 7 for each of the one or more vehicles 12 or for each of the one or more terminal apparatuses 13.

The steps pertaining to the various information processing by the server apparatus 10, the vehicle 12, and the terminal apparatus 13 in FIGS. 5 through 7 are performed by the respective controllers 23, 33, 43. The steps pertaining to transmitting and receiving various types of information to and from the server apparatus 10, the vehicle 12, and the terminal apparatus 13 are performed by the respective controllers 23, 33, 43 transmitting and receiving information to and from each other via the respective communication interfaces 21, 31, 41. In the server apparatus 10, the vehicle 12, and the terminal apparatus 13, the respective controllers 23, 33, 43 appropriately store the information that is transmitted and received in the respective memories 22, 32, 42. Furthermore, the controllers 23, 33, 43 accept input of various information by the respective input interfaces 35, 45 and output various information by the respective output interfaces 36, 46.

FIG. 5 illustrates the procedures for the server apparatus 10 to collect history information for the vehicle 12. The terminal apparatus 13 that performs the procedures illustrated in FIG. 5 is a terminal apparatus used by the user of the vehicle 12 or by a sales representative at the dealer.

Step S500 is, for example, performed once when the user of the vehicle 12 starts using the vehicle 12. In step S500, the terminal apparatus 13 transmits consent information, regarding the disclosure of history information, to the server apparatus 10. For example, when starting to use the vehicle 12, the user of the vehicle 12 expresses consent or non-consent to disclose, to a third party, the history information obtained from the vehicle 12 during use by the user. The user or sales representative operates the terminal apparatus 13 to input information indicating consent or non-consent. The consent information includes the date and time of the expression of consent or non-consent and information indicating consent or non-consent. The consent information is accompanied by identification information for the user and identification information for the vehicle 12. The identification information for the user includes a name, address, and the like. The identification information for the vehicle 12 includes a manufacturer, model, year, serial number, and the like. The terminal apparatus 13 accesses a portal site operated by the dealer on the server apparatus 10, for example, to acquire and display information for an input screen. The terminal apparatus 13 displays the input screen using a display and accepts information inputted by operation of keys or a touch panel. Such information may be inputted by an operation to select from among displayed choices. The user or sales representative inputs the consent information indicating consent or non-consent along with the identification information for the user and the identification information for the vehicle 12. The terminal apparatus 13 transmits the inputted information to the server apparatus 10. The server apparatus 10 receives the information transmitted from the terminal apparatus 13.

Steps S502 and S504 are performed over any appropriate cycle when the vehicle 12 is used by the user. The cycle is, for example, from a few seconds to several hours.

In step S502, the vehicle 12 transmits detection information to the server apparatus 10. The detection information is information, acquired in the vehicle 12, regarding the condition of the vehicle 12. In the vehicle 12, the controller 33 acquires positional information from the positioner 34 and detection results of sensors from the detector 37 and transmits detection information including the positional information and the detection results to the server apparatus 10. The detection information includes information on the date and time when the positional information and detection results were each acquired. The detection information also includes the identification information for the vehicle 12. The identification information for the vehicle 12 is stored in the memory 32 in advance. The server apparatus 10 receives the information transmitted from the vehicle 12.

In step S504, the server apparatus 10 generates or updates history information regarding the condition of the vehicle 12 based on the detection information acquired from the vehicle 12. In the server apparatus 10, the controller 23 generates the history information from detection information. The history information includes, for example, the distance traveled, hazard light activation history, diagnostic code occurrence history, history of abnormalities in the engine, transmission, motor system, suspension, brake pressure, battery, and the like, oil change history, and airbag deployment history. The controller 23 generates these pieces of history information based on the detection information using any appropriate algorithm. History information indicating the time spent (including driving and parking) in each area, such as urban areas, mountainous areas, coastal areas, and areas with snowfall, is generated from the positional information and the date and time of acquisition of the positional information. The areas may be classified arbitrarily on a map or may be based on classifications made by official agencies. The time spent per area may also be a count of trips through the area. History information indicating a count of occurrences of vibration suggestive of a minor collision is also generated from detection information indicating the acceleration acting on the vehicle body. Each instance of acceleration that exceeds a freely set standard is added to the count of occurrences of vibration. History information indicating a count of occurrences of flooding is also generated from detection information indicating the occurrence of flooding. History information indicating the time elapsed since an engine oil change is generated from detection information on the remaining amount, concentration, viscosity, and the like of the engine oil. History information indicating a count of occurrences of proximity events with another object is also generated from detection information such as whether information is outputted to warn of proximity to another object, for example another vehicle, a roadside installation, or a building, and whether intervention in driving operations to avoid contact with another object is required. Proximity events include, for example, an activation history of the hazard lights. The server apparatus 10 then stores the identification information for the vehicle 12, the consent information regarding disclosure of the history information for the vehicle 12, and the history information for the vehicle 12 in association. Upon receiving new detection information from the vehicle 12, the server apparatus 10 updates the history information by generating new history information and adding the new history information to the existing history information.

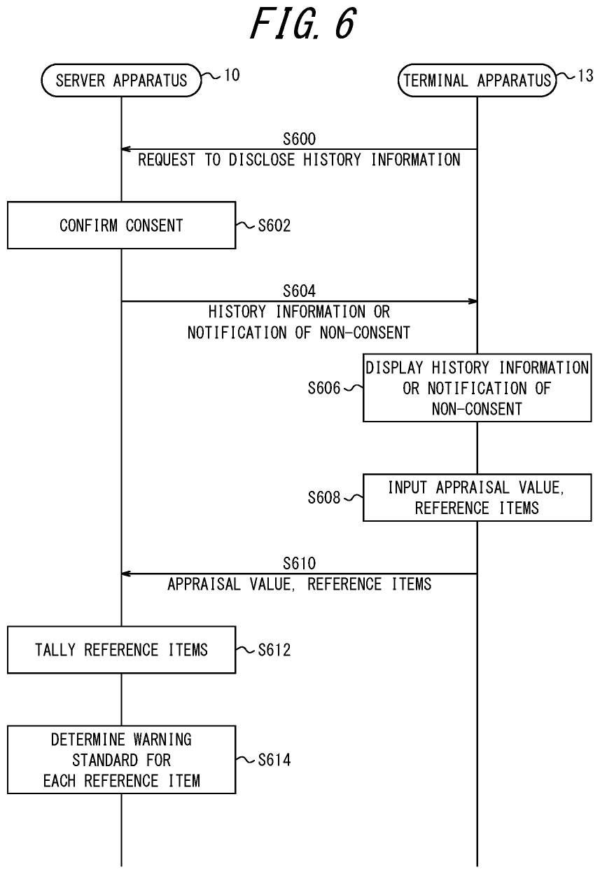

FIG. 6 illustrates the procedure when the server apparatus 10 discloses the history information for the vehicle 12. The terminal apparatus 13 that performs the procedure illustrated in FIG. 6 is a terminal apparatus used by the appraiser of the vehicle 12.

Step S600 is performed when, for example, an appraiser appraises the vehicle 12 to determine the appraisal value of the vehicle 12 at the request of a user who wishes to sell the vehicle 12. In step S600, the terminal apparatus 13 transmits a request to the server apparatus 10 to disclose the history information for the vehicle 12. An instruction requesting disclosure of the history information for the vehicle 12 is inputted to the terminal apparatus 13 by the appraiser, along with the identification information for the vehicle 12, the identification information for the user of the vehicle 12, the identification information for the appraiser, and the like. The terminal apparatus 13 transmits a request to the server apparatus 10 for the history information for the vehicle 12 along with the inputted information. The server apparatus 10 receives the information transmitted from the terminal apparatus 13.

In step S602, the server apparatus 10 confirms consent to disclosure of history information. The server apparatus 10 uses the identification information for the user or the identification information for the vehicle 12, transmitted with the disclosure request from the terminal apparatus 13, as a key and refers to the consent information associated with the identification information to confirm whether consent has been given to disclosure of the history information.

In step S604, the server apparatus 10 transmits the history information or a notification of non-consent to the terminal apparatus 13, according to the result of confirmation in step S602. The server apparatus 10 transmits, to the terminal apparatus 13, the history information for the vehicle 12 if consent to disclosure of the history information has been given and a notification of non-consent indicating non-consent to disclosure if consent has not been given. The terminal apparatus 13 receives the information transmitted from the server apparatus 10.

In step S606, the terminal apparatus 13 outputs the history information or the notification of non-consent received from the server apparatus 10. For example, the terminal apparatus 13 presents, to the appraiser, the history information for the vehicle 12 by displaying the history information on a display. This enables the appraiser to appraise the vehicle 12 with reference to the history information. Alternatively, the terminal apparatus 13 presents, to the appraiser, a message displayed on the display to indicate that the history information for the vehicle 12 cannot be disclosed. Such a procedure ensures that history information is disclosed based on the consent from the user.

In step S608, the terminal apparatus 13 accepts input of the appraisal value of the vehicle 12 and the reference items of the history information that affected the appraisal. For example, the terminal apparatus 13 prompts the appraiser to select an appraisal value and reference items. The appraiser inputs the appraisal value to the terminal apparatus 13. The appraiser also selects the reference items that affected the appraisal. For example, the terminal apparatus 13 displays items of history information in list form on the display and accepts a selection made by the appraiser tapping or clicking on a reference item. A reference item is an item that can take a value suggestive of a reduction in the market value of the vehicle 12. The reference item is, for example, the time spent by the vehicle 12 in coastal areas. As the time spent in coastal areas grows longer, the probability that the vehicle body, electrical system, or the like will fail due to salt damage increases. The time spent in coastal areas is therefore used as a reference for appraisal. The reference item is, for example, the count of occurrences of vibration suggestive of a minor collision. As the count of occurrences of vibration increases, the probability that the vehicle body, drive mechanism, electrical system, or the like will fail due to a minor collision increases. This count is therefore used as a reference for appraisal. Furthermore, the reference item is, for example, the count of occurrences of proximity events with another object. As the count of occurrences of proximity events increases, the probability that the vehicle body, drive mechanism, electrical system, or the like will fail due to contact or a minor collision with another vehicle increases. This count is therefore used as a reference for appraisal. Furthermore, the reference item is, for example, the count of occurrences of flooding. As the count of occurrences of flooding increases, the probability that the vehicle body, electrical system, or the like will fail increases. This count is therefore used as a reference for appraisal. Furthermore, the reference item is, for example, the time elapsed since an engine oil change. As the time elapsed is longer, the probability of engine failure increases. The time elapsed is therefore used as a reference for appraisal.

In step S610, the terminal apparatus 13 transmits information on the appraisal value and the reference items to the server apparatus 10. The server apparatus 10 receives the information transmitted from the terminal apparatus 13. The server apparatus 10 aggregates the reference items that affected the appraisal of one or more vehicles 12.

In step S612, the server apparatus 10 tallies the reference items. For each reference item, the server apparatus 10 tallies the number of vehicles 12 for which the reference item affected the appraisal. The server apparatus 10 then selects one or more reference items that affected the appraisal in a number of vehicles 12 exceeding any appropriate standard, for example.

In step S614, the server apparatus 10 determines a warning standard for each selected reference item. The warning standard is a standard for determining whether the value of the reference item is at a level that requires a warning to the user. In other words, the warning standard is such that when the value of the reference item exceeds the warning standard, the probability of a reduction in the appraisal value increases. The controller 23 of the server apparatus 10 may determine the warning standard for each reference item by any appropriate algorithm, or the warning standard for each envisioned reference item may be set in advance and stored in the memory 22. For example, as the warning standard, the controller 23 may use the average of the values of the reference item, any deviation value, or the like in brackets such as the make, model, or year of the vehicle 12.

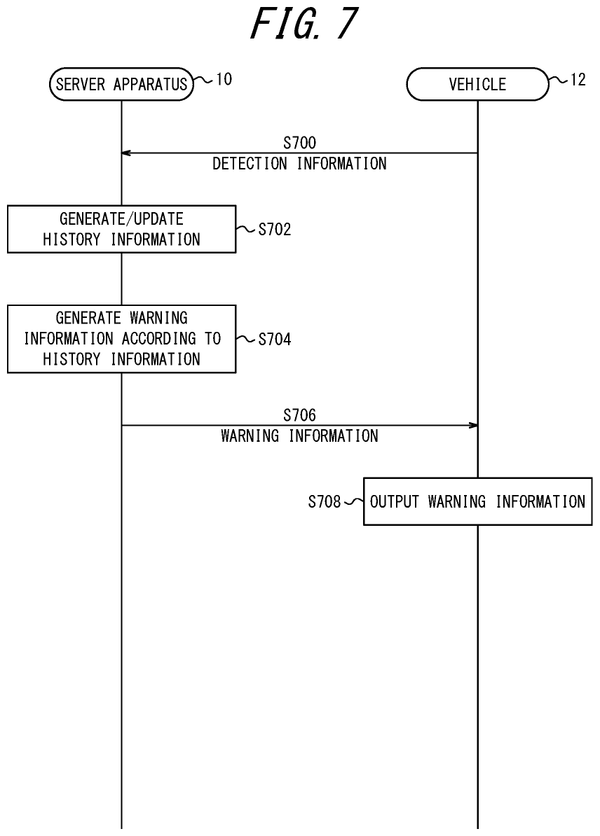

FIG. 7 illustrates the procedures for effective use of the history information for the vehicle 12 collected on the server apparatus 10. The server apparatus 10 performing the procedures in FIG. 7 may be the same apparatus as the server apparatus 10 that performed the procedures in FIGS. 5 and 6, or may be a different apparatus. In the case of a different apparatus, the server apparatus 10 that performed the procedures in FIG. 6 provides the warning standard for each reference item determined in step S614 to the server apparatus 10 that performs the procedures in FIG. 7. The vehicle 12 performing the procedures in FIG. 7 may be the same vehicle as the vehicle 12 appraised in FIGS. 5 and 6 or may be a different vehicle.

Steps S700 to S708 are performed over any appropriate cycle when the vehicle 12 is in use. The cycle is, for example, from a few seconds to several hours.

In step S700, the vehicle 12 transmits detection information to the server apparatus 10. The detection information includes information on the date and time at which the positional information and detection results were obtained respectively, along with the identification information for the vehicle 12. The server apparatus 10 receives the information transmitted from the vehicle 12.

In step S702, the server apparatus 10 generates or updates history information regarding the condition of the vehicle 12 based on the detection information acquired from the vehicle 12. Upon receiving new detection information from the vehicle 12, the server apparatus 10 updates the history information by generating new history information and adding the new history information to the existing history information.

In step S704, the server apparatus 10 generates warning information to be transmitted to the vehicle 12 according to the history information. The warning information is information for presenting a warning to the user when the history information exhibits a predetermined form, i.e., when the history information exceeds the warning standard, and includes a message to be audibly output or displayed. Regarding the history information, generated in step S702, for the vehicle 12, the controller 23 determines whether the value of the reference item selected in step S612 exceeds the warning standard set in step S614. When the value of the reference item exceeds the warning standard, the controller 23 generates warning information for outputting a message that leads to suppression of the value of the reference item.

For example, if the values of reference items such as time spent in costal areas, the count of occurrences of vibration, the count of occurrences of proximity events, the count of occurrences of flooding, and the time elapsed since an oil change increase beyond the warning standard, the probability of a lower appraisal value for the vehicle 12 increases. Warning information is therefore generated for the user. For example, when the time spent in coastal areas exceeds the warning standard, warning information is generated for outputting a message such as, “Please avoid driving (or parking) in coastal areas”. When the count of occurrences of vibration or proximity events exceeds the warning standard, warning information is generated for outputting a message such as, “Please be careful to avoid contact with your surroundings”. Furthermore, when the count of occurrences of flooding exceeds the warning standard, information is generated for outputting a message such as, “Please be careful to avoid flooding”. Furthermore, when the time elapsed since an oil change exceeds the warning standard, warning information is generated for outputting a message such as, “Please change the oil as soon as possible”. Such warning information may be associated in advance with each envisioned reference item and stored in the memory 22.

The controller 23 may include the average value of the reference item for a vehicle of the same make, model, and year as the vehicle 12 in the warning information. The average value is derived when the warning standard is determined in step S614. The correlation between the service life and the value of the reference item for a vehicle of the same make, model, and year as the vehicle 12 may be stored in the memory 22, and based on this information, the controller 23 may include the service life, or the number of remaining years of the service life, expected from the value of the reference item in the warning information. Furthermore, the correlation between the value of a reference item and maintenance costs for a vehicle of the same make, model, and year as the vehicle 12 may be stored in the memory 22, and based on that information, the controller 23 may include the additional maintenance costs expected from the value of reference item in the warning information.

In step S706, the server apparatus 10 transmits the warning information to the vehicle 12. The vehicle 12 receives the warning information transmitted by the server apparatus 10.

In step S708, the vehicle 12 outputs the warning information received from the server apparatus 10. Based on the warning information, the vehicle 12 outputs a message to the user by audio output or display. When the warning information includes information such as the average value of basis items, the service life, or the maintenance costs, this information is also outputted by audio output or display. The vehicle 12 outputs the warning information at any timing that does not interfere with driving, such as when the ignition is turned on, or at the start or end of a trip. Upon receiving such warning information, users can modify their driving. For example, by receiving warning information regarding reference items such as the time spent in coastal areas, the count of occurrences of vibration, the count of occurrences of proximity events, the count of occurrences of flooding, and the time elapsed since an oil change, the user can use the vehicle 12 while making efforts to avoid driving (or parking) in coastal areas, to be aware of surrounding objects, to avoid flooding, and to change the oil sooner. In a case in which the warning information includes information on the average value of reference items, the service life, and additional maintenance costs for a vehicle of the same make, model, and year, such information can also be presented to the user for a more specific alert. This can suppress a decrease in the market value of the vehicle 12, thereby ensuring a higher appraisal value.

In a case in which the value of the reference item is not a value such that warning information is generated, steps S704 through S708 are omitted.

The warning standard for each reference item determined in step S614 of FIG. 6 may have a plurality of stages. In this case, the server apparatus 10 may generate different warning information for each stage. For example, as the value of the reference item increases, the probability of a lower appraisal value increases. The degree of warning can therefore be made stronger in stages. For example, the display form, the volume of sound, or the like can be changed in a way that attracts greater attention.

The server apparatus 10 may store, in the memory 22, the history of the values of reference items having exceeded the warning standard for the vehicle 12 and may provide information on the history of having exceeded the warning standard when the vehicle 12 is traded and a new user begins using the vehicle 12. For example, in step S500 of FIG. 5, around the time when the terminal apparatus 13 transmits consent information regarding the disclosure of history information to the server apparatus 10, the server apparatus 10 transmits information indicating the history of having exceeded the warning standard to the terminal apparatus 13, and the terminal apparatus 13 displays the information to the new user. In this way, the new user can be cautioned to use the vehicle 12 in a manner that takes into account the increasing trend in the values of the reference items.

The above explanation exemplifies a case in which the user owns the vehicle 12, and the vehicle 12 is appraised by an appraiser when sold. However, the present embodiment is also applicable in a case in which the user leases the vehicle 12, and after conclusion of the lease agreement, the leasing company appraises the vehicle 12 for resale.

As described above, according to the present embodiment, the history information obtained from the vehicle 12 can be used effectively.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A server apparatus comprising:
a communication interface; and a controller configured to communicate using the communication interface, wherein
the controller
receives, from a terminal apparatus, information indicating an item of history information that affects appraisal of a first vehicle among history information regarding a condition of the first vehicle; and
transmits, to a second vehicle, information for presentation to a user when the item of history information regarding a condition of the second vehicle exhibits at least one predetermined form.

2. The server apparatus according to claim 1, wherein the controller transmits the history information for the first vehicle to a terminal apparatus that provides information to an appraiser of the first vehicle on condition that a user of the first vehicle has consented to disclosure of the history information for the first vehicle.

3. The server apparatus according to claim 1, wherein in a case in which the item includes time spent in coastal areas, the predetermined form is an increase in time spent in coastal areas by the second vehicle.

4. The server apparatus according to claim 1, wherein in a case in which the item includes a count of occurrences of flooding, the predetermined form is an increase in the count of occurrences of flooding in the second vehicle.

5. The server apparatus according to claim 1, wherein in a case in which the item includes a count of occurrences of proximity to another object, the predetermined form is an increase in the count of occurrences of proximity to another object by the second vehicle.

6. The server apparatus according to claim 1, wherein in a case in which the item includes time elapsed since an oil change, the predetermined form is an increase in time elapsed since an oil change in the second vehicle.

7. The server apparatus according to claim 1, wherein the at least one predetermined form comprises a plurality of predetermined forms, and the controller transmits information to the second vehicle for presentation to the user for each predetermined form in the plurality of predetermined forms.

8. An information provision system comprising a vehicle and a server apparatus configured to communicate with the vehicle, wherein
the server apparatus receives, from a terminal apparatus, information indicating an item of history information that affects appraisal of a first vehicle among history information regarding a condition of the first vehicle and transmits, to a second vehicle, information for presentation to a user when the item of history information regarding a condition of the second vehicle exhibits at least one predetermined form, and
the second vehicle outputs the information for presentation to the user.

9. The information provision system according to claim 8, wherein the server apparatus transmits the history information for the first vehicle to a terminal apparatus that provides information to an appraiser of the first vehicle on condition that a user of the first vehicle has consented to disclosure of the history information for the first vehicle.

10. The information provision system according to claim 8, wherein in a case in which the item includes time spent in coastal areas, the predetermined form is an increase in time spent in coastal areas by the second vehicle.

11. The information provision system according to claim 8, wherein in a case in which the item includes a count of occurrences of flooding, the predetermined form is an increase in the count of occurrences of flooding in the second vehicle.

12. The information provision system according to claim 8, wherein in a case in which the item includes a count of occurrences of proximity to another object, the predetermined form is an increase in the count of occurrences of proximity to another object by the second vehicle.

13. The information provision system according to claim 8, wherein in a case in which the item includes time elapsed since an oil change, the predetermined form is an increase in time elapsed since an oil change in the second vehicle.

14. The information provision system according to claim 8, wherein the at least one predetermined form comprises a plurality of predetermined forms, and the server apparatus transmits information to the second vehicle for presentation to the user for each predetermined form in the plurality of predetermined forms.

15. A method of operating an information provision system comprising a vehicle and a server apparatus configured to communicate with the vehicle, the method comprising:
receiving from a terminal apparatus, by the server apparatus, information indicating an item of history information that affects appraisal of a first vehicle among history information regarding a condition of the first vehicle;
transmitting to a second vehicle, by the server apparatus, information for presentation to a user when the item of history information regarding a condition of the second vehicle exhibits a predetermined form; and
outputting, by the second vehicle, the information for presentation to the user.

16. The method of operating an information provision system according to claim 15, wherein the server apparatus transmits the history information for the first vehicle to a terminal apparatus that provides information to an appraiser of the first vehicle on condition that a user of the first vehicle has consented to disclosure of the history information for the first vehicle.

17. The method of operating an information provision system according to claim 15, wherein in a case in which the item includes time spent in coastal areas, the predetermined form is an increase in time spent in coastal areas by the second vehicle.

18. The method of operating an information provision system according to claim 15, wherein in a case in which the item includes a count of occurrences of flooding, the predetermined form is an increase in the count of occurrences of flooding in the second vehicle.

19. The method of operating an information provision system according to claim 15, wherein in a case in which the item includes a count of occurrences of proximity to another object, the predetermined form is an increase in the count of occurrences of proximity to another object by the second vehicle.

20. The method of operating an information provision system according to claim 15, wherein in a case in which the item includes time elapsed since an oil change, the predetermined form is an increase in time elapsed since an oil change in the second vehicle.
